(19) United States
(12) Patent Application Publication
(10) Pub. No.: US 2025/0325089 A1
(43) Pub. Date: Oct. 23, 2025

(54) MAKEUP PENCIL HOLDING APPARATUS

(71) Applicant: Fulicia Peoples, Glendale, AZ (US)

(72) Inventor: Fulicia Peoples, Glendale, AZ (US)

(21) Appl. No.: 18/639,644

(22) Filed: Apr. 18, 2024

(51) Int. Cl. A45D 40/20; B43K 23/00

(52) U.S. Cl. CPC A45D 40/20; B43K 23/00

(57) ABSTRACT

A pencil holding apparatus for facilitating gripping a short pencil includes a handle which is elongated between a first end and a second end. A plurality of arms is coupled to and extends away from the first end of the handle. The arms are radially spaced from each other and are movable inwardly to grasp a pencil therebetween. An outer surface of each arm of the plurality of arms is angled outwardly. A sleeve is movably mounted to the handle and is movable across the outer surfaces of the arms to urge the arms inwardly.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pencil holding apparatuses and more particularly pertains to a new pencil holding apparatus for facilitating gripping a short pencil.

### (2) Description of Related Art Including Information Disclosed Under 37 CFR 1.97 and 1.98

As makeup pencils and other pencils become shorter with use and sharpening, they become more difficult to grip with one's fingers. A device is needed to improve a user's grip on such shortened pencils so that the user can more easily grip such pencils without placing the user's hands in uncomfortable positions or dropping the pencil due to a lost grip.

### BRIEF SUMMARY OF THE INVENTION

An embodiment of the disclosure meets the needs presented above by generally comprising a handle which is elongated between a first end and a second end. A plurality of arms is coupled to and extends away from the first end of the handle. The arms are radially spaced from each other and are movable inwardly to grasp a pencil therebetween. An outer surface of each arm of the plurality of arms is angled outwardly. A sleeve is movably mounted to the handle and is movable across the outer surfaces of the arms to urge the arms inwardly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pencil holding apparatus according to an embodiment of the disclosure.

FIG. 2 is a side view of an embodiment of the disclosure.

FIG. 3 is a cross-section view of an embodiment of the disclosure taken from Line 3-3 in FIG. 2.

FIG. 4 is an exploded in-use view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

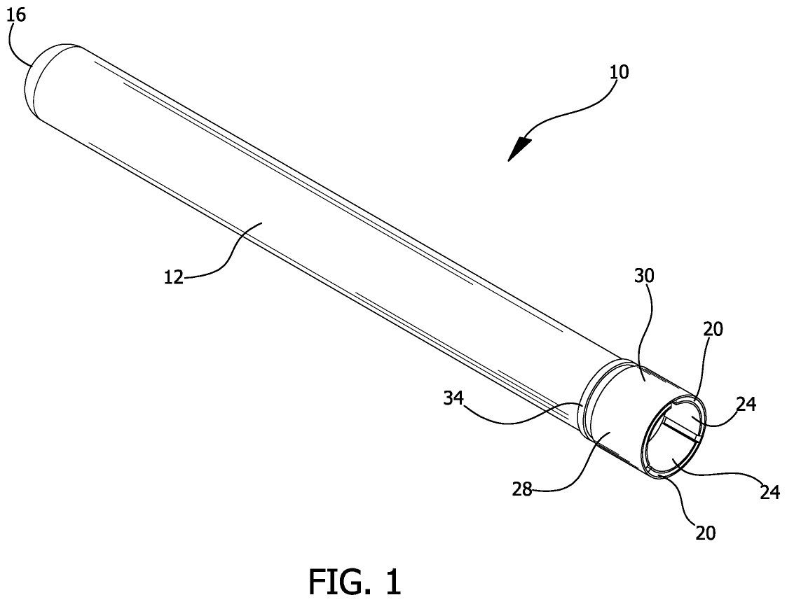

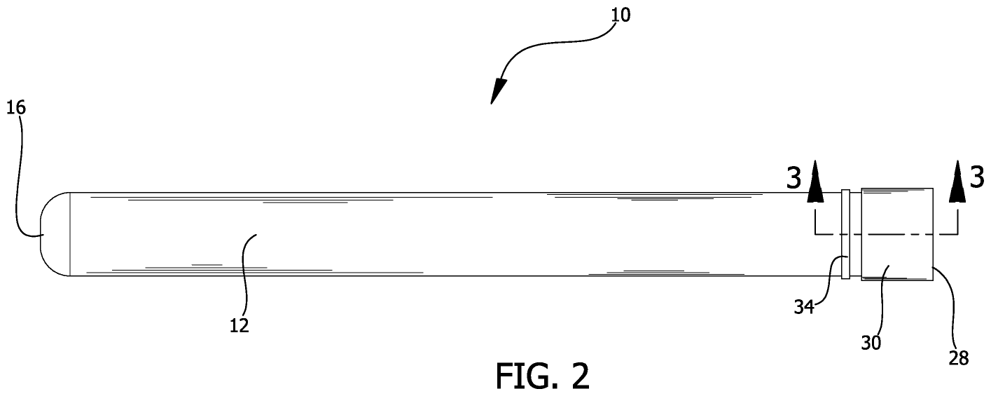

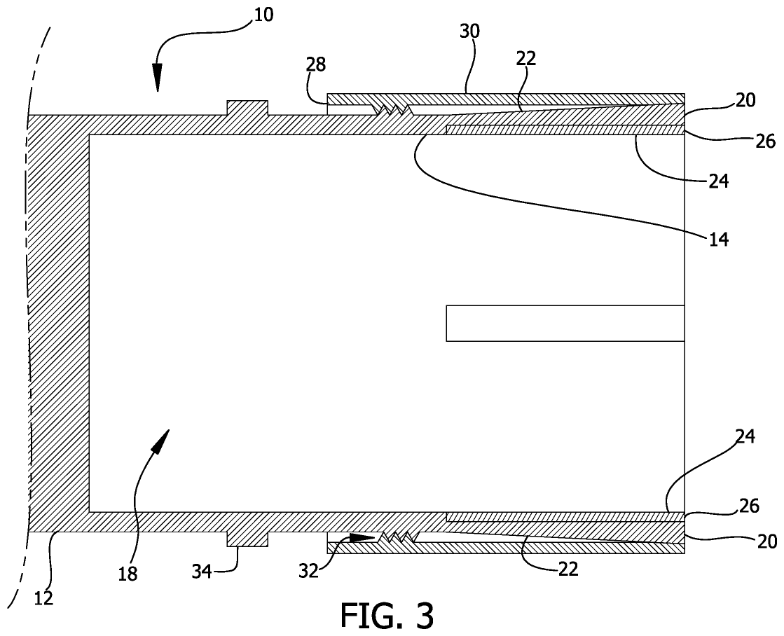

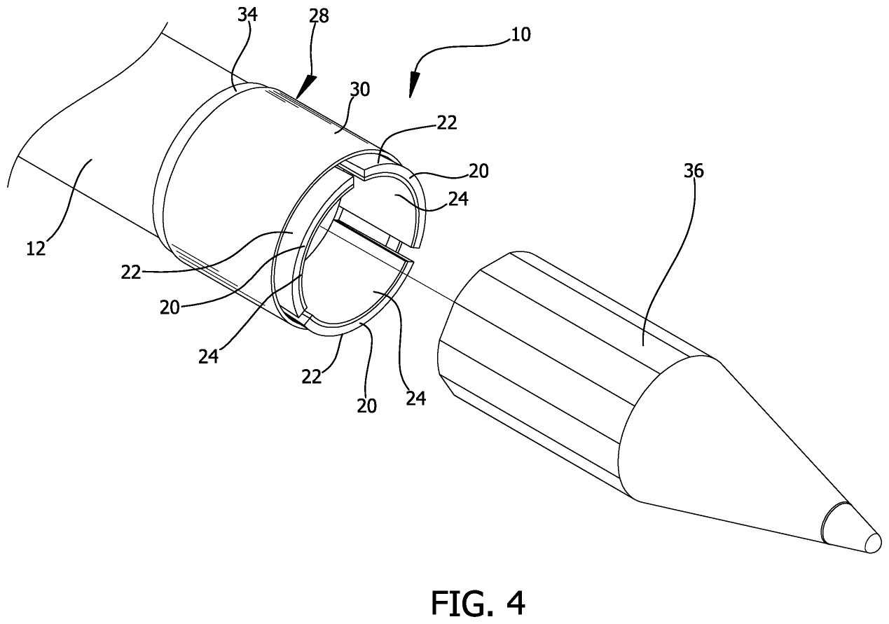

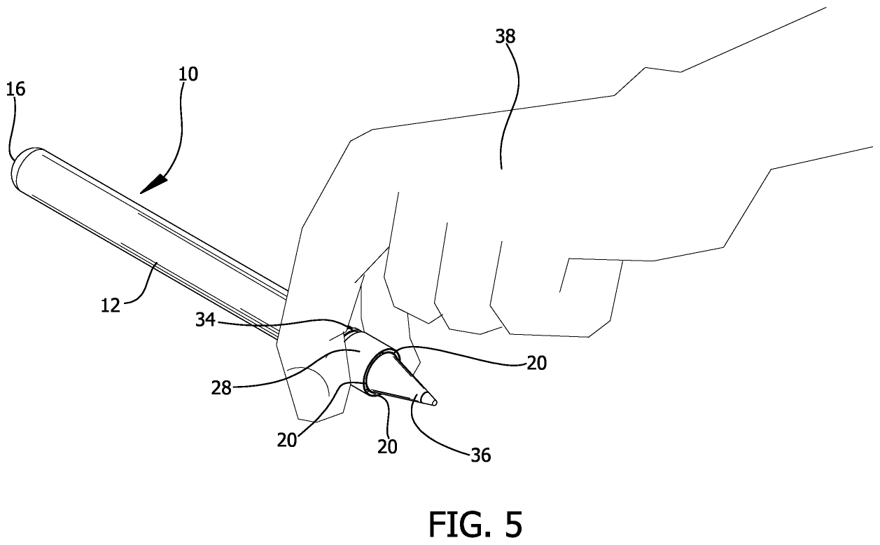

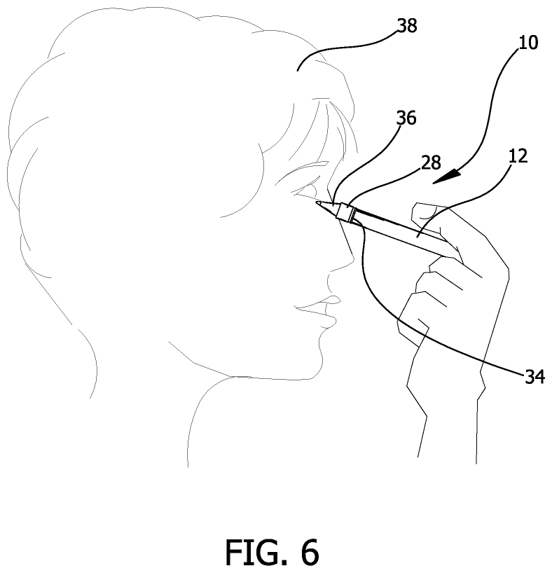

With reference now to the drawings, and in particular to FIGS. 1 through 6 thereof, a new pencil holding apparatus embodying the principles and concepts of an embodiment of the disclosure and generally designated by the reference numeral 10 will be described.

As best illustrated in FIGS. 1 through 6, the pencil holding apparatus 10 generally comprises a handle 12 which is elongated between a first end 14 and a second end 16. The handle 12 defines a channel 18 therein which is open at the first end 14. A plurality of arms 20 is coupled to and extends away from the first end 14 of the handle 12. The arms 20 are radially spaced from each other and are movable inwardly to grasp a pencil 36 therebetween. Each arm 20 comprises a resiliently bendable material so that the arm 20 may be bent inwardly with respect to the handle 12 and rebound outwardly when released. An outer surface 22 of each arm 20 of the plurality of arms 20 is angled outwardly with respect to the handle 12. An inner portion 26 of each arm 20 of the plurality of arms 20 comprises a frictionally enhanced material such as rubber, silicone, or the like. An inner surface 24 of each arm 20 is concave, and the outer surface 22 of each arm 20 is convex.

A sleeve 28 is movably mounted to the handle 12. The sleeve 28 surrounds the handle 12 and is movable across the outer surfaces 22 of the arms 20 to urge the arms 20 inwardly via a threaded coupling 32 to the handle 12. By rotating the sleeve 28 a first rotational direction, the sleeve 28 is urged via the threaded coupling 32 toward the second end 16 of the handle 12 away from the arms 20. By rotating the sleeve 28 in a second rotational direction opposite the first rotational direction, the sleeve 28 is urged via the threaded coupling 32 across the outer surfaces 22 of the arms 20 to urge the arms 20 inwardly. An exterior 30 of the sleeve 28 may be frictionally enhanced via a texture or a material such as rubber, silicone, or the like.

A stop flange 34 is mounted to and extends around the handle 12. The stop flange 34 is positioned between the first end 14 and the second end 16 of the handle 12 and is positioned to stop the sleeve 28 when the sleeve 28 is moved from the first end 14 of the handle 12 toward the second end 16.

In use, the pencil 36 is inserted between the arms 20. If long enough, the pencil 36 may be moved past the arms 20 into the channel 18 of the handle 12. To secure the pencil 36 to the handle 12, the sleeve 28 is rotated in the second direction to close the arms 20 around the pencil 36. The handle 12 may then be grasped by a user 38 to use the pencil 36 as desired. To release the pencil 36 from the handle 12, the sleeve 28 is rotated in the first rotational direction until the arms 20 are moved off of the pencil 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pencil holding apparatus comprising:
a handle elongated between a first end and a second end;
a plurality of arms coupled to and extending away from the first end of the handle, the arms being radially spaced from each other, the plurality of arms being movable inwardly to grasp a pencil therebetween, an outer surface of each arm of the plurality of arms being angled outwardly; and
a sleeve movably mounted to the handle, the sleeve being movable across the outer surfaces of the arms to urge the arms inwardly; and
a stop flange mounted to and extending outwardly around the handle, the stop flange being positioned between the first end and the second end of the handle, the stop flange being positioned to abut an end edge of the sleeve to stop the sleeve when the sleeve is moved from the first end of the handle toward the second end.

2. The apparatus of claim 1, wherein the plurality of arms comprises a resiliently bendable material.

3. The apparatus of claim 1, wherein an inner portion of each arm of the plurality of arms comprises a frictionally enhanced material.

4. The apparatus of claim 1, wherein the sleeve is mounted to the handle via a threaded coupling.

5. (canceled)

6. The apparatus of claim 1, wherein the handle defines a channel therein which is open at the first end.

7. The apparatus of claim 1, wherein an inner surface of each arm is concave.

8. The apparatus of claim 1, wherein an outer surface of each arm is convex.

9. A pencil holding apparatus comprising:
a handle elongated between a first end and a second end, the handle defining a channel therein which is open at the first end;
a plurality of arms coupled to and extending away from the first end of the handle, the arms being radially spaced from each other, the plurality of arms being movable inwardly to grasp a pencil therebetween, the plurality of arms comprising a resiliently bendable material, an outer surface of each arm of the plurality of arms being angled outwardly, an inner portion of each arm of the plurality of arms comprising a frictionally enhanced material, an inner surface of each arm being concave, the outer surface of each arm being convex;
a sleeve movably mounted to the handle, the sleeve being movable across the outer surfaces of the arms to urge the arms inwardly, the sleeve being mounted to the handle via a threaded coupling; and
a stop flange mounted to and extending outwardly around the handle, the stop flange being positioned between the first end and the second end of the handle, the stop flange being positioned to abut an end edge of the sleeve to stop the sleeve when the sleeve is moved from the first end of the handle toward the second end.
